(19) United States
(12) Patent Application Publication
(10) Pub. No.: US 2014/0356497 A1
(43) Pub. Date: Dec. 4, 2014

(54) Composition

(71) Applicant: Natural Biotechnology SPRL, Courcelles (BE)

(72) Inventor: Jeffrey Ian Dodd, Lancashire (GB)

(21) Appl. No.: 14/362,111

(22) PCT Filed: Nov. 30, 2012
(86) PCT No.: PCT/GB2012/000877

§ 371 Date: May 30, 2014

(30) Foreign Application Priority Data
Nov. 30, 2011 (GB) 1120616.6

(51) Int. Cl. A23B 7/154; A23B 7/10

(52) U.S. Cl. CPC A23B 7/154; A23B 7/10; A23V 2200/02; A23V 2200/048
USPC 426/268; 426/654; 426/271; 426/545; 426/615

(57) ABSTRACT

There is described a composition useful for the prevention, mitigation or slowing of the discolouration of produce (fruit) the composition comprising from about 0.05% w/w to about 99.95% w/w calcium ascorbate, and derivatives thereof, the remainder comprising an enzyme inhibitor composition.

### FIELD OF THE INVENTION

The present invention relates to a novel composition and to novel methods related thereto.

More particularly, the invention relates a novel composition suitable for extending the storage life of fresh produce, such as fruit and vegetables. The use of the composition and the method of the invention prevents or mitigates the spoilage of such fresh produce.

### BACKGROUND OF THE INVENTION

Enzymatic browning is one of the most studied reactions in fruits, vegetables and seafood. Researchers in the fields of food science, horticulture, plant physiology, including postharvest physiology, microbiology and insect and crustacean physiology, have studied this reaction because of the diversity of its commercial impact upon growers, food processors and consumers.

Many of the research programs have demonstrated successful formulations for preserving processed fruit, vegetables, fish, poultry and meat, but these formulations have proven commercially non-viable due to, inter alia, the expense and/or limited availability of intermediates.

Appearance, flavour, texture and nutritional value are four attributes considered by consumers when making food choices. Appearance, which is significantly impacted by colour, is one of the first attributes used by consumers in evaluating food quality.

When asked to discuss discolouration or browning in foods, those involved from production to processing, usually reflect on its detrimental influence.

Discolouration or browning in fruits and vegetables also gives rise to economic losses.

Increases in fruit and vegetable markets projected for the future will not occur if enzymatic discolouration or browning is not understood more and controlled. Enzymatic discolouration and browning is one of the most devastating reactions for many exotic fruits and vegetables, in particular tropical and subtropical varieties. It is estimated that over 50% of losses in fruit occur as a result of enzymatic discolouration or browning (Whitaker and Lee, 1995). Such losses have prompted considerable interest in understanding and controlling phenol oxidase enzymes in foods. Lettuce, other green leafy vegetables, potatoes and other starchy staples, such as sweet potato, breadfruit, yam, mushrooms, apples, avocados, bananas, grapes, peaches, and a variety of other tropical and subtropical fruits and vegetables, are susceptible to discolouration or browning and therefore cause economic losses for the agriculturist. These losses are greater if discolouration or browning occurs closer to the consumer in the processing scheme, due to storage and handling costs prior to this point.

The control of discolouration or browning from harvest to consumer is therefore very critical for minimising losses and maintaining economic value to the agriculturist and food processor. Discolouration or browning can also adversely affect flavour and nutritional value of fruit and vegetables.

Decolouration, e.g. browning, of fresh produce, such as, fruit and vegetables is undesirable, especially for retailers and customers. Decolouration is anaesthetic and perceived by consumers to indicate that the produce is spoiled. Therefore, processors and retailers aim to prevent or minimise decolouration.

Such decolouration will generally not occur in undamaged or unprepared produce. However, there is an increased demand for prepared fruits and vegetables and therefore the prevention or mitigation of decolouration of such prepared foods is especially important for the retailer of such produce. If the produce is discoloured then the consumer will generally not purchase the product as it is perceived as being damaged.

Enzymic browning is an important colour reaction in fruit and vegetables and in some instances enzymic browning is desirable, for example in developing the flavour of tea and developing the colour and flavour in dried fruits such as figs or raisins.

However, enzymatic browning of many fruits and vegetables may be undesirable and can create economic losses for growers, retailers, etc. This decolouration or browning does not occur in undamaged or uncut fruit and/or vegetables since natural phenolic substrates are separated from the enzyme(s) responsible for browning hence the decolouration will not occur. However once the produce has been cut, peeled, damaged so that the flesh of the fruit or vegetable is exposed to air, rapid decolouration or browning will occur. This discolouration or browning, of produce such as fruit and vegetables, is often referred to as “enzymic browning” or “enzymatic browning”. Enzymic browning comprises a chemical or biochemical process which involves the enzyme polyphenol oxidase (phenolase), and other enzymes, such as, tyrosinase and catecholase. The enzyme is released when the fruit or vegetable is cut or damaged and discolouration is generally due to enzymic oxidation of phenols to orthoquinones, etc. the orthoquinones very quickly polymerise to form coloured/brown pigments known as melanins. Melanins are a class of pigments which are derived from the amino acid tyrosine and it is the melanin, or similar compounds in its class, which produces the brown colour observed in fresh produce as hereinbefore described.

The increase in the sale of pre-prepared fruits and vegetables has increased the need for the prevention of discolouration so as to increase at least the perceived shelf life of such produce.

Conventionally, enzymatic browning is controlled with chemicals (such as sodium bisulphite), or by destroying the responsible chemicals with heat, for example, blanching is commonly used to destroy the enzyme(s) and to preserve the colour in fruit and/or vegetables. Lemon juice and other acids have been used to preserve the colour in fruit, particularly apples, by lowering the pH.

However, a disadvantage with many conventionally known anti-browning agents is their inability to penetrate fruits and/or vegetables quickly.

Sulphites, such as sodium metabisulphite, are known to penetrate fruits and vegetables, quickly and have been used extensively with root vegetables, such as potatoes. However, the use of sulphites is disadvantageous in that, when opening sulphite treated pre-packed vegetables, such as potatoes, there can be a “whiff” of a sulphurous odour. There are also medical issues related to the use of sulphites, such as asthma and other respiratory malfunctions.

Other potential anti-browning agents have been investigated including, for example, anti oxidants, acidulants, chelating agents, enzyme inhibitors and inorganic salts. However, many of them suffer from the disadvantage that they are expensive and/or not commercially available.

International patent application No. WO 99/07230 in the name of Mantrose Haeuser, (equivalent to U.S. Pat. No. 5,939,117) describes a calcium ascorbate composition which is suitable as an anti-browning composition however, such a composition is disadvantageous in that, inter alia, large amounts of ascorbate are required to be use which is undesirable and costly. More specifically, WO '230 describes a method for preserving fresh fruit comprising a preservative comprising 0.5 to 100% calcium ascorbate and O to 99.5% water. WO '230 exemplifies the use of various concentrations of calcium ascorbate, including 3% w/v (Example 1); 2.80%, 3.54%, 3.83%, 3.08%, 2.81%, 3.15%, 2.98% and 3.07% (Example 2); 0.5% and 1.5% (Example 3); 0.25%, 0.050%, 1.00%, 1.50% and 2.00% (Example 3a); 5, 10, 15, 22.5% (Example 3b); 3.8% (Example 4); 34% (Example 5); 1.32% (Example 6); 3.8% (Examples 7 to 10); and 0.98% (Example 11). However, it should be noted that the low concentrations, such as 0.25% are considered to be unsatisfactory since, for example, they would not preserve Red Delicious apples beyond about 1 hour.

International patent application No. WO 2004/086872, in the name of Freshxtend Technologies Limited, describes compositions for preserving cut apples comprising ascorbic acid with a concentration of 5.0% to 9% w/w; and calcium ions with a concentration of 0.4% to 0.68% w/w. WO '872 exemplifies the use of various of ascorbic acid and calcium chloride, including 8% (w/w) consisting of, inter alia, 82.5% (w/w) ascorbic acid, 10% (w/w) calcium chloride dehydrate (Example 2); and 84.2% (w/w) ascorbic acid, 5% (w/w) calcium chloride (Example 3).

### SUMMARY OF THE INVENTION

We have now surprisingly found that significantly lower concentrations of calcium ascorbate, and derivatives thereof, may be used in combination with a natural organic acidulant to provide satisfactory protection against browning of produce, such as fruit and especially apples.

Thus, according to a first aspect of the present invention there is provided a composition useful for the prevention, mitigation or slowing of the discolouration of produce (fruit) the composition comprising from about 0.05% w/w to about 99.95% w/w calcium ascorbate, and derivatives thereof, the remainder comprising an enzyme inhibitor composition.

Preferably, the composition of the present invention comprises from about 0.05% w/w to about 90% w/w calcium ascorbate from about 0.05% w/w to about 80%w/w calcium ascorbate from about 0.05% w/w to about 70% w/w calcium ascorbate from about 0.05% w/w to about 60% w/w calcium ascorbate from about 0.05% w/w to about 50% w/w calcium ascorbate from about 0.05% w/w to about 40% w/w calcium ascorbate from about 0.05% w/w to about 30% w/w calcium ascorbate from about 0.05% w/w to about 20% w/w calcium ascorbate from about 0.05% w/w to about 10% w/w calcium ascorbate from about 0.05% w/w to about 5% w/w calcium ascorbate from about 0.05% w/w to about 1% w/w calcium ascorbate most preferably from about 0.05% w/w to about 0.4% w/w calcium ascorbate, the remainder comprising an enzyme inhibitor composition.

The calcium ascorbate, and derivatives thereof, may be present in the composition in a variety of forms. The ascorbate itself may be present as ascorbate ions or isoascorbate (erythorbate) ions, and combinations thereof. Thus, by the term “derivatives thereof” shall mean, inter alia, isoascorbate.

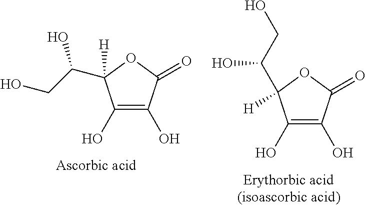

The calcium ascorbate, and derivatives thereof, may be present simply as the calcium salt of ascorbic acid, and derivatives thereof. Alternatively or in addition, the calcium ascorbate, and derivatives thereof, may be present as calcium ions wherein the calcium ions and ascorbate ions are from separate sources.

Thus, the calcium ions may be in the form of one or more of, e.g. in the form of one or more of the group consisting of calcium chloride, e.g. calcium chloride dehydrate, calcium hydroxide, calcium carbonate, calcium phosphate, calcium erythorbate, calcium acetate, calcium gluconate, calcium glycerophosphate, calcium lactate, calcium ascorbate and mixtures thereof.

The source of the ascorbate ion may be ascorbic acid, erythorbic acid, or an ascorbate or erythorbate salt, such as calcium ascorbate or calcium erythorbate, and mixtures thereof.

Preferably calcium ascorbate is the source for both the calcium ion and the ascorbate ion.

When the calcium ascorbate, and derivatives thereof, is present as separate ascorbate ions and calcium ions, as hereinbefore described, the (molar) ratio of ascorbate ion, and derivatives thereof, to calcium ion may be from about 0.1:1 to about 1.4:1, preferably from about 0.5:1 to about 1.4:1, preferably from about 0.75:1 to about 1.4:1, preferably from about 1:1 to about 1.4:1, preferably from about 1.2:1 to about 1.4:1.

The composition of the invention may comprise calcium ascorbate, and derivatives thereof, as hereinbefore described, from about 0.05% w/w to about <0.4% w/w, preferably from about 0.1% w/w to about <0.4% w/w, or from about 0.2% w/w to about <0.4% wfw, from about 0.3% w/w to about <0.4% w/w, e.g. about 0.35% w/w. In one aspect of the invention the enzyme inhibitor composition may comprise a variety of enzyme inhibitors, however, preferentially the enzyme inhibitor is a phenolase inhibitor, for example, which has an effect on phenolase by reducing the pH of the environment to below 4 the level at which phenolase is inactivated. Such an enzyme inhibitor may comprise a combined treatment of an acidulant and a reducing agent. In the combined treatment according to this aspect of the invention may comprise the use separately, sequentially or simultaneously of an acidulant and a reducing agent. A preferred enzyme inhibitor is natural organic acid enzyme inhibitor, e.g. a naturally occurring organic acid, such as, tannic acid, and derivatives thereof.

Thus, it will be understood that tannic acid may have a dual function in the present invention of acting as both a chelating agent, an enzyme inhibitor.

The person skilled in the art will understand that tannic acid is generally a mixture of polyphenols with a pKa of about 6, commercially available tannic acid is suitable for use as a chelating agent and/or an enzyme inhibitor in the present invention.

The natural organic acid enzyme inhibitor may optionally be dissolved in an acidic solution, for example, an aqueous solution of ascorbic acid/sorbitol.

The enzyme inhibitor may also include an enzyme carrier, such as a D-glucosamine polysaccharide, e.g. chitosan. When chitosan is present it may be in an amount of from 0.01 to 1% (w/w)

The enzyme inhibitor may function as an acidulant and thereby has an inhibitory effect on phenolase, for example, by reducing the pH to below the level at which is required to inactivate phenolase. The optimum pH of phenolase activity varies with the source of the enzyme and the particular substrate, e.g. fruit or vegetable, etc., but generally phenolase has an optimum activity at a pH of from 6 to 7. Therefore, according to this aspect of the invention the acidulant is selected from those that will reduce the pH to below 4. In an especially preferred aspect of the invention the acidulant will reduce the pH to about 3. In an especially preferred aspect of the invention the acidulant will reduce the pH to about 2.64.

The enzyme inhibitor composition may include a chelating agent component. The chelating agent is one which has an affinity to copper or iron; and salts thereof. Such a chelating agent is advantageously an acidulant which may also reduce the pH of the environment. Examples of such a chelating agent are organic chelating acids, such as, citric acid or a combination of citric acid and tannic acid, and derivatives thereof and combinations thereof. A preferred chelating agent is a combination of citric acid and tannic acid. When the chelating agent comprises a combination of citric acid and tannic acid the ratio of a citric acid: tannic acid may be from about 1:10 to 10:1, preferably about 1:5 to 5:1, more preferably from about 1:2 to 2:1, e.g. about 1:1.

The amount of chelating agent present may vary depending upon, inter alia, the substrate being treated. However, the amount of chelating agent, e.g. tannic acid/citric acid combination, present in the enzyme inhibitor composition may be from about 0.1% to about 5% (w/v), preferably from about 0.1% to about 4% (w/v).

In addition to the aforementioned, when the chelating agent is in association with an acidulant (organic or inorganic) the acidulant may be an acidified salt, such as, acidified sodium chloride, e.g. sodium hydrogen sulphate (NaHSO₄). The modified acidified salt may be a mixture of sodium hydrogen sulphate as hereinbefore described and erythorbic acid/erythorbate salt complex, e.g. 0.1 to 2.% w/w). The enzyme inhibitor may function as an acidulant and thereby has an inhibitory effect on phenolase, for example, by reducing the pH to below the level at which is required to inactivate phenolase. The optimum pH of phenolase activity varies with the source of the enzyme and the particular substrate, e.g. fruit or vegetable, etc., but generally phenolase has an optimum activity at a pH of from 6 to 7. Therefore, according to this aspect of the invention the acidulant is selected from those that will reduce the pH to below 4. In an especially preferred aspect of the invention the acidulant will reduce the pH to about 3. In an especially preferred aspect of the invention the acidulant will reduce the pH to about 2.64.

The enzyme inhibitor composition may optionally include one or more of a chelating agent, as hereinbefore described, and an antioxidant, and/or a sugar. Thus, the combination of an enzyme inhibitor, and optionally one or more of a chelating agent, an antioxidant and a sugar, may be present together in a solution.

The one or more of an antioxidant, and a sugar may comprise materials conventionally known to the person skilled in the art. However, although a variety of antioxidants may be used a preferred antioxidant is erythorbic acid ((2R)-2-[(1R)-1,2-dihydroxyethyl]-4,5-dihydroxyfuran-3-one), and salts thereof, such as, sodium erythorbate. A further preferred antioxidant may be kojic acid (5-hydroxy-2-(hydroxymethyl)-4-pyrone), or a salt thereof. Kojic acid is also known to be a chelating agent. A preferred antioxidant in the present invention may be a combination of erythorbic acid, or a salt thereof and kojic acid, or a salt thereof.

The amount of the antioxidant, e.g. a mixture of two or more of erythorbic acid/erythorbate salt/kojic acid, present may also vary and may be from about 0.25% to about 6.0% (w/v), preferably from about 0.5% to about 5% (w/v), more preferably from about 1% to about 4% (w/v). When the antioxidant comprises a mixture or complex of erythorbic acid/erythorbate salt/kojic acid the ratio of erythorbic acid/erythorbate salt kojic acid may be from about 1:10 to 10:1, preferably about 1:5 to 5:1, more preferably from about 1:2 to 2:1, e.g. about 1:1.

A variety of antioxidants (or reducing agents) may be used which are known to the person skilled in the art. Thus, a preferred antioxidant or reducing agent is erythorbic acid/erythorbate salt combination. Erythorbic acid/erythorbate is a reducing agent which functions as a free radical scavenger preventing oxidation by altering the REDOX potential of the system and reduces undesirable oxidative products. Erythorbic acid/erythorbate salt complex generally acts as an antioxidant in that oxygen preferentially reacts with the erythorbic acid/erythorbate salt complex, rather than the phenolic compounds in the fruit or vegetables and therefore decolouration does not begin until the entire erythorbic acid/erythorbate salt complex is used up. Furthermore, the erythorbic acid/erythorbate salt complex reduces any orthoquinones that are present to colourless diphenols.

According to a further aspect of the invention there is provided a method for the prevention, mitigation or slowing of the discolouration of produce (fruit) the method comprising:
(i) an optional first step of pre-dipping the produce in a chelating agent; and
(ii) treating the optionally pre-dipped produce with a calcium ascorbate/enzyme inhibitor composition as hereinbefore described.

Optionally, in the method of the invention the treatment with calcium ascorbate and an enzyme inhibitor may be carried out separately, sequentially or simultaneously.

According to one aspect of the invention we provide a method as hereinbefore described wherein the pre-dipping step is present.

According to an alternative aspect of the invention we provide a method as hereinbefore described wherein the pre-dipping step is absent.

Therefore, according to a further aspect of the invention we provide a composition suitable for the prevention of the discolouration of produce (fruit) comprising an optional pre-dipping chelating component and a calcium ascorbate/enzyme inhibitor component.

The chelating component and calcium ascorbate/enzyme inhibitor component are each as hereinbefore described.

According to a yet further aspect of the invention we provide a kit suitable for the prevention of the discolouration of produce (fruit) the kit comprising:
(i) an optional pre-dipping component; and
(ii) a calcium ascorbate/enzyme inhibitor component.

According to this aspect of the invention, the calcium ascorbate/enzyme inhibitor component in the kit may comprise a single component, e.g. a composition as hereinbefore described, or the calcium ascorbate and enzyme inhibitor component may be separate, such that they may be applied to the produce (fruit) separately, sequentially or simultaneously. Preferably, the calcium ascorbate and enzyme inhibitor component are present as a single composition.

According to one aspect of the invention we provide a kit as herein before described in which the pre-dipping component is present.

According to an alternative aspect of the invention we provide a kit as hereinbefore described in which the pre-dipping component is absent.

In the composition or kit as hereinbefore described, the optional pre-dipping component may comprise a chelating agent. Thus, as hereinbefore described the chelating agent should have an affinity to copper or iron and salts thereof. It will be understood that more than one chelating agent may be present, for example, a copper selective chelating agent may be combined with an iron selective chelating agent. The chelating agent may be an acidulant which may reduce the pH of the environment, such as citric acid.

In the composition or kit as hereinbefore described, the enzyme inhibitor may comprise a combined treatment of an acidulant, reducing agent and an enzyme inhibitor such as tannic acid, and optionally acidified salt (sodium hydrogen sulphate). Therefore, the acidulant is selected from those that will reduce the pH to below 4. In an especially preferred aspect of the invention the acidulant will reduce the pH to about 2.64.

In the composition or kit as hereinbefore described, the reducing agent or antioxidant may preferentially be erythorbic acid/erythorbate salt complex. The binding agent may be chitosan,

According to yet a further aspect of the invention we provide produce (fruit) treated with a composition method or kit as hereinbefore described. Such produce is advantageous in that, inter alia, if it has been peeled sliced or diced, it has a shelf life. By the term shelf life used herein, we mean the period for which the produce may be kept without discolouration and alteration to texture and taste occurring.

By the term “shelf life” used herein, we mean the period for which the produce may be kept without discolouration and alteration to colour, texture and taste occurring.

1. A composition useful for the prevention, mitigation or slowing of the discolouration of produce (fruit) the composition comprising from about 0.05% w/w to about 99.95% w/w calcium ascorbate, and derivatives thereof, the remainder comprising an enzyme inhibitor composition.

2. A composition according to claim 1 wherein the calcium ascorbate, and derivatives thereof, is present as calcium ions and ascorbate ions from separate sources.

3. A composition according to claim 1 wherein the calcium ions are in the form of one or more of the group consisting of calcium chloride, e.g. calcium chloride dehydrate, calcium hydroxide, calcium carbonate, calcium phosphate, calcium erythorbate, calcium acetate, calcium gluconate, calcium glycerophosphate, calcium lactate, calcium ascorbate and mixtures thereof.

4. A composition according to claim 1 wherein the source of the ascorbate ion may be ascorbic acid, erythorbic acid, or an ascorbate or erythorbate salt, such as calcium ascorbate or calcium erythorbate, and mixtures thereof.

5. (canceled)

6. A composition according to claim 1 wherein the calcium ascorbate, and derivatives thereof, is present as separate ascorbate ions and calcium ions and the ratio of ascorbate ion, and derivatives thereof, to calcium ion is from about 0.1:1 to about 1.4:1.

7. A composition according to claim 1 wherein the composition comprises calcium ascorbate, and derivatives thereof, of from about 0.05% w/w to about <0.4% w/w.

8.-10. (canceled)

11. A composition according to claim 1 wherein the natural organic acid enzyme inhibitor is tannic acid, and derivatives thereof.

12. A composition according to claim 1 wherein the natural organic acid is capable of reducing the pH of the environment to below 4.

13. A composition according to claim 1 wherein the acidic solution comprises an aqueous solution of ascorbic acid/sorbitol.

14.-16. (canceled)

17. A composition according to claim 1 wherein the enzyme inhibitor composition includes a chelating agent component.

18.-25. (canceled)

26. A composition according to claim 1 wherein the modified acidified salt may be a mixture of sodium hydrogen sulphate and erythorbic acid/erythorbate salt.

27. A composition according to claim 1 wherein the erythorbic acid/erythorbate salt is present in an amount of from 0.1 to 2% w/w.

28. A composition according to claim 1 wherein the composition includes one or more of antioxidant and/or a sugar.

29.-31. (canceled)

32. A method for the prevention, mitigation or slowing of the discolouration of produce (fruit) the method comprising:
(i) an optional first step of pre-dipping the produce in a chelating agent; and
(ii) treating the optionally pre-dipped produce with a calcium ascorbate/enzyme inhibitor composition.

33.-36. (canceled)

37. A kit suitable for the prevention of the discolouration of produce (fruit) the kit comprising:
(i) an optional pre-dipping component; and
(ii) a calcium ascorbate/enzyme inhibitor component.

38. (canceled)

39. A kit according to claim 37 wherein the calcium ascorbate and enzyme inhibitor component are separate, such that they may be applied to the produce (fruit) separately, sequentially or simultaneously.

40.-45. (canceled)

46. A kit according to claim 37 wherein the enzyme inhibitor is a natural organic acid that is capable of reducing the pH of the environment to below 4.

47. A kit according to claim 37 wherein the natural organic acid is tannic acid, or a derivative thereof.

48.-52. (canceled)

53. A kit according to claim 37 wherein the enzyme inhibitor is capable of reducing the pH to below 4.

54.-57. (canceled)

58. Produce (fruit) treated with a composition according to claim 1.

59. (canceled)
